(19) United States
(12) Patent Application Publication
(10) Pub. No.: US 2024/0091098 A1
(43) Pub. Date: Mar. 21, 2024

(54) SYSTEMS FOR VIBRATIONALLY EXCITING A LARYNGEAL NERVE

(71) Applicant: Passy-Muir, Inc., Irvine, CA (US)

(72) Inventors: Alex Jolly, Newport Beach, CA (US); Cameron Jolly, Newport Beach, CA (US); Kristin King, Littleton, NC (US); Jose Comino, Irvine, CA (US); Daniel Carrillo, Irvine, CA (US); Wayne Fong, Irvine, CA (US); Kenneth Green, La Habra Heights, CA (US)

(21) Appl. No.: 18/524,927

(22) Filed: Nov. 30, 2023

Related U.S. Application Data
(63) Continuation of application No. 17/887,299, filed on Aug. 12, 2022, now Pat. No. 11,850,205.
Application No. 17/887,299 is a continuation of application No. 17/305,282, filed on Jul. 2, 2021, now Pat. No. 11,413,214.
Application No. 17/305,282 is a continuation of application No. 16/853,477, filed on Apr. 20, 2020, now abandoned.
(60) Provisional application No. 62/836,195, filed on Apr. 19, 2019.

(51) Int. Cl. A61H 23/02

(52) U.S. Cl. CPC A61H 23/02; A61H 2201/1611; A61H 2201/165; A61H 2201/501; A61H 2201/5071; A61H 2205/04

(57) ABSTRACT

A laryngeal nerve exciting system includes a collar holding a bridge, or a neckband, pressing soft tissue nerve exciters against a patient's neck providing a source of vibrations to stimulate the laryngeal nerve through the larynx. At least one exciter, and preferably two exciters, provide vibrations at preferably 70 Hz to 110 Hz and sufficiently strong to penetrate to the laryngeal nerve. The exciters may be held by the collar circling the neck, or by the neck band partially circling the neck. The therapy system includes a Personal Digital Assistant (PDA) and software which wirelessly connects, monitors, and triggers the device. The system may be used to treat dysphagia, chronic cough, and spasmodic dysphonia.

### CROSS-REFERENCE TO RELATED APPLICATIONS

The application is a continuation of U.S. patent application Ser. No. 17/887,299, filed Aug. 12, 2022, which is a continuation of U.S. patent application Ser. No. 17/305,282, filed Jul. 2, 2021, now U.S. Pat. No. 11,413,214, issued Aug. 16, 2022 which is a continuation of U.S. patent application Ser. No. 16/853,477, filed Apr. 20, 2020, now abandoned, which claims the priority of U.S. Provisional Patent Application No. 62/836,195, filed Apr. 19, 2019, the disclosures of each of which is incorporated in its entirety herein by reference.

### BACKGROUND

The present invention relates to human tissue stimulation and in particular to noninvasive vibration on the neck overlying the larynx to excite the laryngeal nerve to augment or reestablish swallowing control during rehabilitation of patients with dysphagia, and to treat voice disorders affecting the function of the laryngeal system, such as spasmodic dysphonia, and to treat chronic cough.

Dysphagia is a major swallowing disorder that effects the central nervous system, and the peripheral nervous system, thereby weakening neuromuscular control and effectively reducing the ability to properly swallow. Dysphagia may occur at any time across the lifespan. This impairment has many potential causes, including but not limited to neurologic disorders, degenerative disease processes, and anatomical changes. Dysphagia is characterized by difficulty swallowing, impaired ability to protect the airway during swallowing (penetration and aspiration), and impaired ability to transport a bolus of food or liquid from the mouth to the stomach. These difficulties may contribute to a risk for respiratory complications (pneumonia), dehydration, malnutrition, and may restrict social eating. Because of these negative impacts, it also may significantly impact quality of life for an individual.

An occasional cough is normal in that it helps to clear irritants and secretions from the lungs; however, when a cough lasts longer than eight weeks in adults and begins to interfere with daily functions, such as sleep and bladder control, then it may be diagnosed as a chronic cough. In children, this diagnosis may occur after four weeks of coughing. Chronic cough occurs in the upper airway of the respiratory system, and the condition may be caused by co-morbidities, such as asthma, post-nasal drip, or reflux. However, the mechanism is unknown. The cough reflex may be impaired by a disease condition that weakens the cough which could lead to muscle weakness or paralysis, or it may be secondary to laryngeal nerve involvement.

Spasmodic dysphonia is a disorder that may occur with neurological disorders or disease processes that impact laryngeal function and muscles of the voice. This disorder of the laryngeal system causes the muscles involved in voicing to periodically spasm, triggering increased tension and a distortion of the voice. The spasms cause interruptions and breaks in the voice. Causes of spasmodic dysphonia are unknown but may relate to such processes as anxiety, infection, or direct injury to the larynx. It is more common in women and occurs most often between the ages of 30-50 years.

Any neurologic disease or process that impacts laryngeal function may negatively impact swallowing, voicing, and airway functions such as cough and throat clear, or any function that originates within or requires function of the laryngeal system. Various functions within the laryngeal system occur due to stimulation of the afferent pathways which transmit impulses to the brain and are then interpreted for communication with the efferent system for movement. Current treatment for an impairment or changes of laryngeal function that is caused by various neurological disorders or laryngeal injury are typically long-term behavioral therapy or invasive treatment with the injection of foreign materials or medications into the muscles, nerves, or tissues of the larynx. However, various disorders, such as dysphagia, chronic cough, and voicing disorders, may be improved by innervation of the afferent system within the larynx including the branches of the vagus nerve, such as the recurrent laryngeal, superior laryngeal, and pharyngeal branches, and vibration is known to relax muscles and to provide stimulation to tissues being innervated offering an alternative treatment.

U.S. Pat. No. 8,388,561 describes a vibrotactile stimulator having a band 101 worn around a patient's neck and including a vibrator 102 positionable over the larynx to provide stimulation generally centered on the patient's neck. The vibrator 102 is an electric motor spinning an offset weight. While the '561 patent provides a potential method for addressing dysphagia, there remains a need for improved dysphagia therapy devices.

### SUMMARY

The present invention addresses the above and other needs by providing a vibrating laryngeal nerve exciting device which includes a collar holding a bridge, or a neckband, pressing soft tissue nerve exciters against a patient's neck providing a source of vibrations to stimulate the branches of the vagus nerve, such as the recurrent laryngeal, superior laryngeal, and pharyngeal branches. At least one exciter, and preferably two exciters, provide vibrations preferably adjustable between 30 Hz and 200 Hz and more preferably between 70 and 110 Hz and sufficiently strong to penetrate to the laryngeal nerve, for example, a pressure of 2-4 kpa or a vibration amplitude of 0.15 mm to 0.25 mm. The exciters may be held by the collar circling the neck, or by the neck band partially circling the neck. The therapy system includes a Personal Digital Assistant (PDA) device and software which wirelessly connects, monitors, and triggers the device. The system may be used to treat dysphagia, chronic cough, and spasmodic dysphonia.

In accordance with one aspect of the invention, there is provided software (e.g., a smartphone application) which wirelessly connects and triggers the device, for example, through a Bluetooth® protocol. The software sets the frequency of the device, intensity, therapy time, vibration time, duration of rest period between vibration, and allows for patients to provide feedback about the therapy. A general state of health section allows the patient to diary how the patient is feeling before and after the therapy. The software allows clinicians to monitor the patient's progress. The clinician can see the device settings (frequency of the device, intensity, therapy time, vibration time, duration of rest period between vibration), number of uses, whether therapy was completed, and the patient's feedback diary.

### BRIEF DESCRIPTION OF THE DRAWINGS

The above and other aspects, features and advantages of the present invention will be more apparent from the following more particular description thereof, presented in conjunction with the following drawings.

FIG. 1A shows a front view of a laryngeal nerve exciter according to the present invention.

FIG. 1B shows a top view of the laryngeal nerve exciter according to the present invention.

FIG. 1C shows a rear view of the laryngeal nerve exciter according to the present invention.

FIG. 2 shows an end effector of the laryngeal nerve exciter according to the present invention.

FIG. 3 shows a top view of a second embodiment of a laryngeal nerve exciter according to the present invention.

FIG. 4 shows a neckband laryngeal nerve exciter according to the present invention on a patent.

FIG. 5 shows a top view of the neckband laryngeal nerve exciter according to the present invention.

FIG. 6 shows a perspective view of the neckband laryngeal nerve exciter according to the present invention.

FIG. 7 shows a nerve exciter of the neckband laryngeal nerve exciter according to the present invention.

FIG. 8 shows an adhesive pad of the neckband laryngeal nerve exciter according to the present invention.

FIG. 9 shows a laryngeal nerve exciting system according to the present invention.

Corresponding reference characters indicate corresponding components throughout the several views of the drawings.

### DETAILED DESCRIPTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

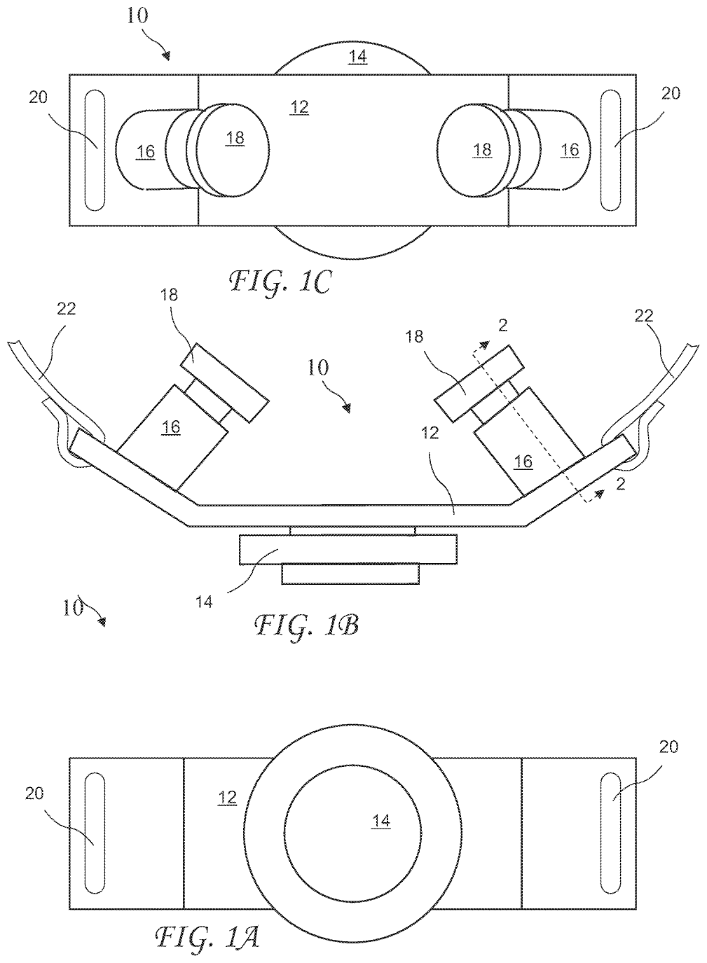

A front view of a laryngeal nerve exciter 10 according to the present invention is shown in FIG. 1a, a top view of the laryngeal nerve exciter 10 is shown in FIG. 1B, and a rear view of the laryngeal nerve exciter 10 is shown in FIG. 1C. The laryngeal nerve exciter 10 includes a bridge 12, an exciter 14, effector sleeves 16, end effectors 18, strap slots 20, and a strap 22. The exciter 14 is preferably a solenoid or a voice coil, or any device capable of generating vibrations at various frequencies, for example, vibrations between 30 and 200 Hz and preferably between 70 and 110 HZ and sufficiently strong to reach the laryngeal nerve for example, a pressure of 2-4 kpa or a vibration amplitude of 0.15 mm to 0.25 mm.

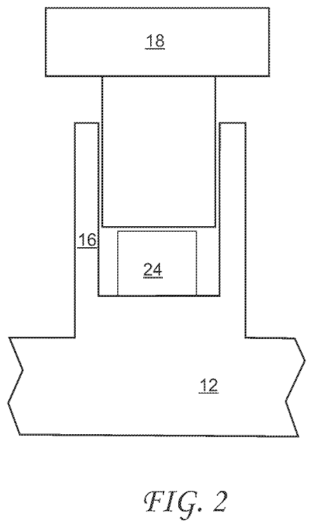

The end effector 18 of the laryngeal nerve exciter 10 is shown in FIG. 2. A force sensor 24 resides under each end effector 18 and provides force information to allow adjusting the tightness of the strap 22.

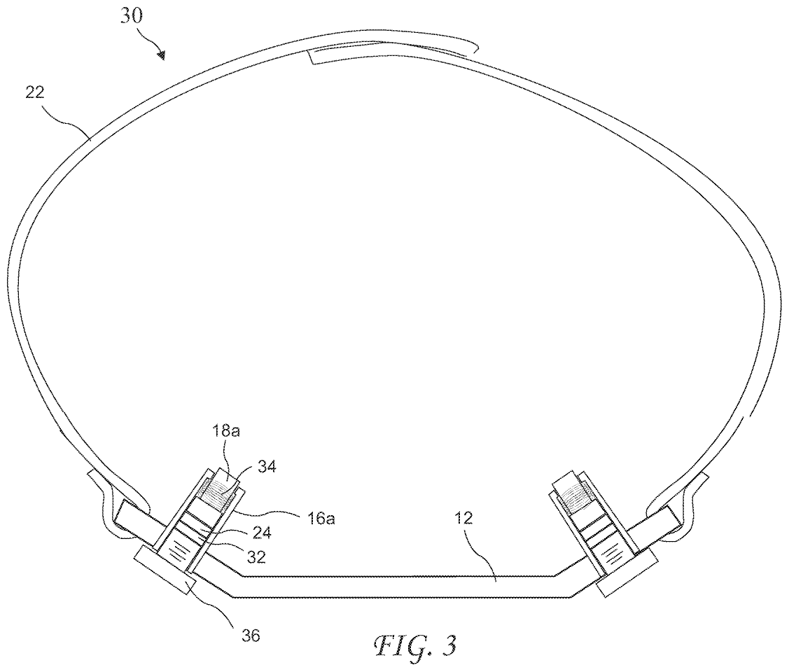

A top view of a second embodiment of a laryngeal nerve exciter 30 is shown in FIG. 3. The laryngeal nerve exciter 30 includes end effectors 18a held inside sleeves 16a and springs (or a resilient material) 34 holding the end effectors 18a against transducers 32. An adjust screw 36 presses the transducer 32 and end effector 18a against the spring 34 allowing adjustment of the end effectors 18a against the patient's neck without adjusting the strap 22. The transducers 32 may both vibrate the end effectors 18a to stimulate the laryngeal nerve and may sense a patient's attempt to swallow, and may sense stimulation by the other end effector 18a. The laryngeal nerve exciter 30 may include the force sensor 24 under the effector 16a. In another embodiment, the end effectors 18a may be fixedly attached to the moving part of the transducers 32 and no spring 34 is required.

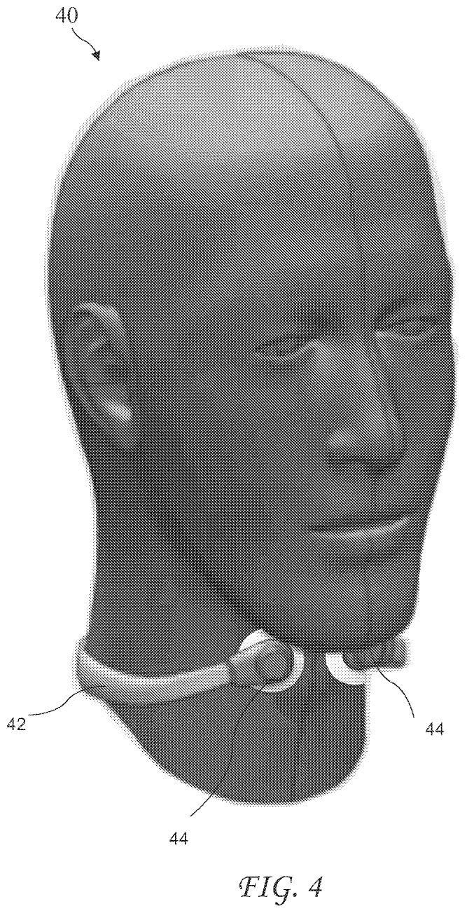

FIG. 4 shows a neckband laryngeal nerve exciter (neckband trainer) 42 on a patient 40. The neckband trainer 42 does not press against the patient's throat providing greater comfort for the patient. Two exciters 44 are pressed against sides of the neck. The exciters 44 preferably receive up to 10 Watts (five Watts per exciter). The neckband trainer 42 provides pressure to the area where the exciters 44 contact the neck. The force of the exciters 44 against the neck is measured and an alarm is generated if the force exceeds a threshold.

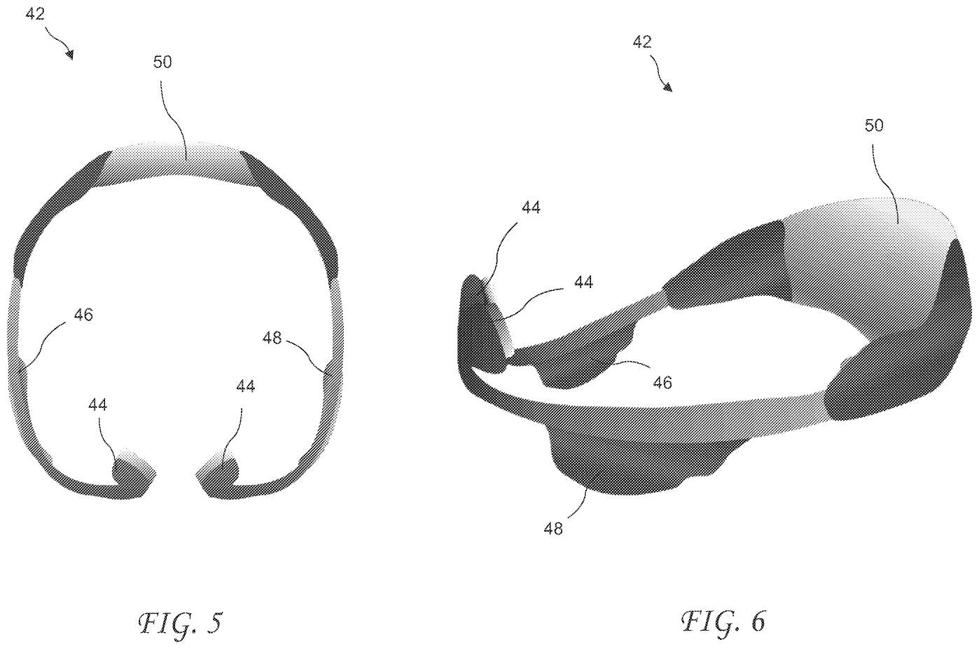

FIG. 5 shows a top view of the neckband trainer 42 and FIG. 6 shows a perspective view of the neckband trainer 42. The neckband trainer 42 includes the exciters 44, a circuit 46, and battery compartments 48 and 50. The neckband trainer 42 includes a charging port for charging batteries and is adjustable for individual patients.

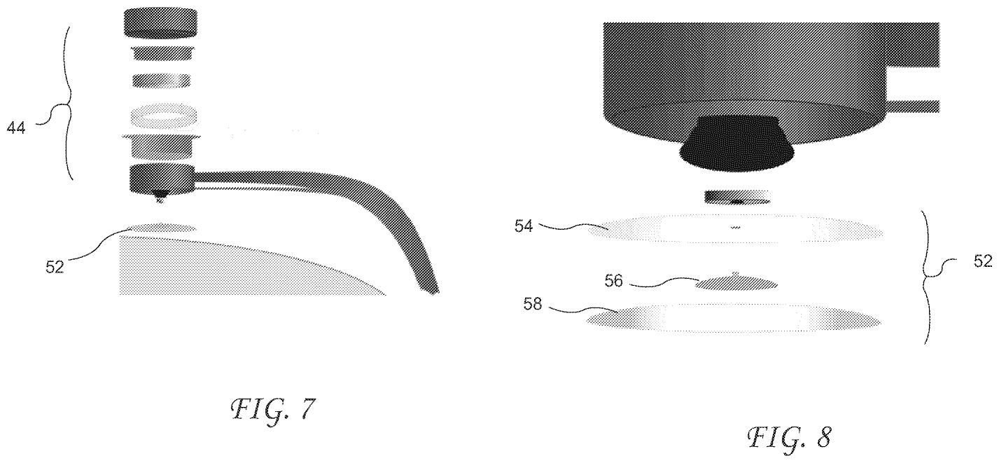

FIG. 7 shows a nerve exciter 44 of the neckband laryngeal nerve exciter.

FIG. 8 shows an adhesive pad 52 of the neckband trainer 42. The adhesive pad 52 comprises a top adhesive pad 54, a plastic snap 56, and a bottom adhesive pad 58. The exciter 44 snaps onto the adhesive pad 52 to retain the exciter 44 against the patient's neck.

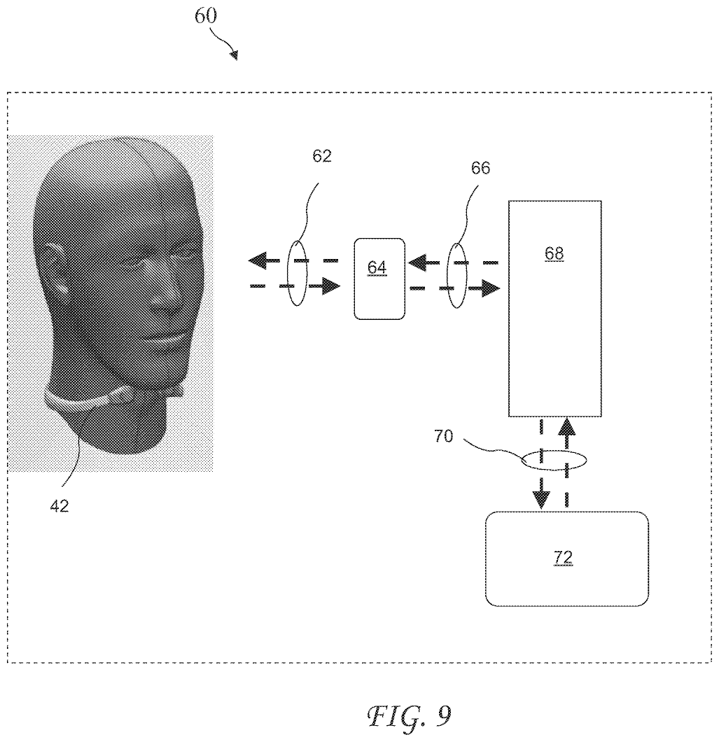

A laryngeal nerve exciter system 60 is shown in FIG. 9. The system 60 utilizes a software Application (App) residing in a Personal Digital Assistant (PDA) 64 which triggers, and monitors the neckband trainer 42 through a Bluetooth® interface 62. The interface 62 may include frequency, intensity, therapy time, vibration time, duration of rest period between vibration, and allows for patients to provide feedback about the therapy.

The PDA 64 may communicate with a secure server 68 through the Internet or any other suitable connection including wireless or wired connections 66 providing signals include frequency, intensity, therapy time, vibration time, duration of rest period between vibration, clinician calibration, and allows for patients to provide feedback about the therapy.

The secure server 68 may communicate with a work station 72 over the Internet or any other suitable connection including wireless or wired connections 70 providing signals include frequency, intensity, therapy time, vibration time, duration of rest period between vibration, and clinician calibration, and allows for patients to provide feedback about the therapy to the clinician.

The App may set the frequency of the neckband trainer 42, intensity, therapy time, vibration time, duration of rest period between vibration, and allows for patients to provide feedback about the therapy. Measurements made by the neckband trainer 42 (e.g., force measured by the exciters) may be provided to the PDA 46 via the Bluetooth® connection. Further, the system 60 may allow clinicians to monitor the patient's progress. The clinician will be able to see the device settings, frequency of the device, intensity, therapy time, vibration time, duration of rest period between vibration, number of uses, whether therapy was completed, and the patient feedback. A general state of health section for the patient may be provided to indicate how the patient is feeling before and after the therapy. The PDA 64 may be a smart phone.

While the invention herein disclosed has been described by means of specific embodiments and applications thereof, numerous modifications and variations could be made thereto by those skilled in the art without departing from the scope of the invention set forth in the claims.

What is claimed is:

1. A laryngeal nerve exciter system for vibrationally exciting a laryngeal nerve to treat at least one of a swallow disorder, a voice disorder, or chronic cough, the system comprising:
a neckband, the neckband comprising a first free end and a second free end opposing each other to form an open front, the first free end and the second free end spaced apart by a distance, the neckband being flexible to accommodate necks of different sizes, the neckband further comprising a center portion facing the open front, a first side portion and a second side portion disposed on opposite sides of the center portion;
a first exciter extending from the first free end of the neckband, the first exciter disposed between the first free end and the first side portion, the first exciter comprising a first surface coupled to the first free end of the neckband and a second surface opposing the first surface;
a second exciter extending from the second free end of the neckband, the second exciter disposed between the second free end and the second side portion, the second exciter comprising a first surface coupled to the second free end of the neckband and a second surface opposing the first surface of the second exciter;
a first electrical circuit and a second electrical circuit configured to respectively control the first exciter and the second exciter,
wherein each of the first side portion and the second side portion comprises a first region and a second region closer to the center portion than the first region, wherein each first region comprises a housing mounted thereon and respectively accommodating the first electrical circuit or the second electrical circuit, and wherein each first region is larger in size than each second region due to the housing; and
a first adhesive pad and a second adhesive pad respectively coupled to the first exciter and the second exciter, each of the first adhesive pad and the second adhesive pad comprising a first surface coupled to the second surface of the corresponding first exciter or the second exciter and a second surface opposing the first surface of the corresponding adhesive pad, the second surfaces of the first adhesive pad and the second adhesive pad being adhesive,
wherein the first adhesive pad and the second adhesive pad are respectively positioned against a first portion and a second portion of the patient's neck different from each other,
wherein the open front of the neckband is configured to expose the patient's throat,
wherein the second surfaces of the first adhesive pad and the second adhesive pad are configured to fix positions of the neckband by adhering to the patient's skin, and
wherein the first exciter and the second exciter are configured to vibrationally excite the laryngeal nerve of the patient to treat at least one of the swallow disorder, the voice disorder, or chronic cough, by generating vibration and conducting the generated vibration to the patient's neck.

2. The system of claim 1, wherein the neckband further comprises a battery compartment disposed at the center portion of the neckband and configured to accommodate a battery.

3. The system of claim 2, wherein the distance between the first free end and the second free end is less than a length of the battery compartment.

4. The system of claim 2, wherein at least one of the first free end, the second free end, or the open front faces the battery compartment.

5. The system of claim 2, wherein the battery compartment is thicker than each of the first side portion and the second side portion of the neckband.

6. The system of claim 5, wherein the first free end and the second free end are respectively coupled to the first side portion and the second side portion in a curved manner having a first curvature.

7. The system of claim 6, wherein the first exciter and the second exciter are respectively coupled to the first free end and the second free end in a direction extending the first curvature.

8. The system of claim 5, wherein the center portion is coupled to the first side portion and the second side portion in a curved manner having a second curvature different from the first curvature.

9. The system of claim 8, wherein a radius of the first curvature is smaller than a radius of the second curvature.

10. The system of claim 1, wherein at least one of a length of the first side portion or a length of the second side portion is fixed.

11. The system of claim 1, wherein at least one of a length of the first side portion or a length of the second side portion is adjustable.

12. The system of claim 1, further comprising:
first and second force sensors configured to measure force of the first exciter and the second exciter against the first and second portions of the patient's neck,
wherein the system is configured to generate an alarm in response to the measured force exceeding a threshold.

13. A laryngeal nerve exciter system for vibrationally exciting a laryngeal nerve to treat at least one of a swallow disorder, a voice disorder, or chronic cough, the system comprising:
a neckband, the neckband comprising a first free end and a second free end opposing each other to form an open front, the first free end and the second free end spaced apart by a distance, the neckband being flexible to accommodate necks of different sizes, the neckband further comprising a center portion facing the open front, a first side portion and a second side portion disposed on opposite sides of the center portion;
a first exciter extending from the first free end of the neckband, the first exciter disposed between the first free end and the first side portion;
a second exciter extending from the second free end of the neckband, the second exciter disposed between the second free end and the second side portion; and
a first electrical circuit and a second electrical circuit configured to respectively control the first exciter and the second exciter,
wherein each of the first side portion and the second side portion comprises a first region and a second region closer to the center portion than the first region, wherein each first region comprises a housing mounted thereon and respectively accommodating the first electrical circuit or the second electrical circuit, and wherein each first region is larger in size than each second region due to the housing.

14. The system of claim 13, wherein the first exciter and the second exciter are configured to vibrationally excite the laryngeal nerve of a patient to treat at least one of the swallow disorder, the voice disorder, or chronic cough, by generating vibration and conducting the generated vibration to the patient's neck.

15. The system of claim 14, wherein the first exciter comprises a first surface coupled to the first free end of the neckband and a second surface opposing the first surface, and wherein the second exciter comprises a first surface coupled to the second free end of the neckband and a second surface opposing the first surface of the second exciter, the system further comprising:
a first adhesive pad and a second adhesive pad respectively coupled to the first exciter and the second exciter, each of the first adhesive pad and the second adhesive pad comprising a first surface coupled to the second surface of the corresponding first exciter or the second exciter and a second surface opposing the first surface of the corresponding adhesive pad, the second surfaces of the first adhesive pad and the second adhesive pad being adhesive,
wherein the first adhesive pad and the second adhesive pad are respectively positioned against a first portion and a second portion of the patient's neck different from each other, and
wherein the second surfaces of the first adhesive pad and the second adhesive pad are configured to fix positions of the neckband by adhering to the patient's skin.

16. The system of claim 13, wherein the neckband further comprises a battery compartment disposed at the center portion of the neckband and configured to accommodate a battery.

17. The system of claim 16, wherein the battery compartment is thicker than each of the first side portion and the second side portion of the neckband.

18. The system of claim 13, wherein the center portion is coupled to the first side portion and the second side portion in a curved manner having a second curvature different from the first curvature.

19. The system of claim 13, wherein at least one of a length of the first side portion or a length of the second side portion is fixed.

20. The system of claim 13, wherein at least one of a length of the first side portion or a length of the second side portion is adjustable.
